(19) United States
(12) Patent Application Publication
(10) Pub. No.: US 2010/0314999 A1
(43) Pub. Date: Dec. 16, 2010

(54) LAMP DEVICE

(75) Inventors: Jin-Yuh Lu, Taipei City (TW); Wei-Yuan Tsou, Daxi Town (TW); Shen-Hong Chou, Toufen Township (TW); Chun-Hsu Lin, Taichung City (TW); Chun-Chieh Huang, Hsinchu City (TW); Chin-Chia Chang, Keelung City (TW); Kuan Ting Chen, Taipei City (TW)

Correspondence Address: SNELL & WILMER L.L.P. (Main), 400 EAST VAN BUREN, ONE ARIZONA CENTER, PHOENIX, AZ, 85004-2202, US

(73) Assignee: WELLYPOWER OPTRONICS CORPORATION, Hsin-Chu (TW)

(21) Appl. No.: 12/815,213

(22) Filed: Jun. 14, 2010

(30) Foreign Application Priority Data
Jun. 16, 2009 (TW) 098120067

(51) Int. Cl. H01K 1/62; H01J 5/00; H01K 1/26

(52) U.S. Cl. 315/32; 313/317; 313/113

(57) ABSTRACT

The present invention provides a lamp device. The lamp device of the present invention comprises a lamp holder, a frame on the lamp holder, and a lamp tube having a height. At least one third of the height of the lamp tube is contacted with the frame to improve mechanical strength of the lamp tube.

### CROSS-REFERENCE TO RELATED APPLICATIONS

This application claims priority to Taiwan Patent Application No. 098120067 entitled “LAMP DEVICE,” filed on Jun. 16, 2009, which is incorporated herein by reference.

### BACKGROUND OF THE INVENTION

1. Field of the Invention

The present invention relates to lamp devices, and more particularly, to a compact fluorescent lamp device.

2. Description of the Prior Art

Unlike incandescent lamps, compact fluorescent lamps (CFL) are characterized by a long service life and power savings, and thus are commercially replacing incandescent lamps.

Referring to FIG. 1, there is shown a simple schematic view of a conventional compact fluorescent lamp (CFL) (commonly known as an energy-saving light bulb) 10. As shown in the drawing, the conventional compact fluorescent lamp 10 comprises a lamp holder 12, a double helical hot cathode fluorescent lamp tube 14 disposed on the lamp holder 12, a circuit board 16 disposed in the lamp holder 12, and a screw thread contact 18 coupled to the lamp holder 12. The lamp tube 14 is filled with inert gas (such as Ar or Ne, not shown) and a trace of mercury atoms (not shown). The inner wall of the lamp tube 14 is coated with a fluorescent substance (not shown).

Regarding the conventional compact fluorescent lamp 10, the lamp tube 14 is usually fixed to the lamp holder 12 via the bottom of the lamp tube 14, thus resulting in insufficient bonding. Also, due to the small diameter of the lamp tube 14 of the compact fluorescent lamp 10, the lamp tube 14 is generally made of glass; hence, the lamp tube 14 is likely to crack when hit from outside or subjected to external impact. Hence, in general, the lamp tube 14 is covered with and thereby protected by a lamp shade 19. But doing so adversely affects shrinkage of the compact fluorescent lamp 10, and reduces the brightness of the light emitted from the lamp tube 14. Additionally, manufacturing costs are also increased. Furthermore, the double helical lamp tube 14 is so closely packed together that it blocks part of the light emitted from the lamp tube, and in consequence the overall brightness of the compact fluorescent lamp 10 is reduced.

### SUMMARY OF THE INVENTION

In view of the above problems, it is an objective of the present invention to provide a lamp device and a frame for improving the mechanical strength of a lamp tube of the lamp device.

In order to achieve the above and other objectives, the present invention provides, in an embodiment, a lamp device. The lamp device comprises: a lamp holder; a frame on the lamp holder; and a lamp tube having a height, wherein at least one third of the height of the lamp tube is in contact with the frame so that the mechanical strength of the lamp tube is improved.

In another embodiment of the present invention, a frame is provided. The frame is configured for use with a lamp device so as to improve the mechanical strength of a lamp tube. A surface of the frame comprises a groove. The groove corresponds in shape to at least one portion of the lamp tube, so as to come into contact with and receive the lamp tube.

In yet another embodiment of the present invention, a frame is provided. The frame is configured for use with a lamp device so as to improve the mechanical strength of a lamp tube. The frame comprises a base and at least one extended member connected to the base. The extended member has a sheet-shaped structure or a strip-shaped structure. The lamp tube is in contact with the extended member.

### BRIEF DESCRIPTION OF THE DRAWINGS

To render the above and other objectives, features, and advantages of the present invention obvious and comprehensible, preferred embodiments of the present invention are described hereunder in conjunction with the accompany drawings, wherein:

FIG. 1 is a simple schematic view of a conventional compact fluorescent lamp;

FIG. 2A and FIG. 2B are diagrams of a lamp device before and after assembly thereof in an embodiment according to the present invention;

FIG. 3 is a simple schematic view of a lamp device provided in another embodiment according to the present invention;

FIG. 4A and FIG. 4B are simple schematic views of a frame provided and a lamp device for use with the frame in yet another embodiment according to the present invention; and

FIG. 5A and FIG. 5B are simple schematic views of a frame provided and a lamp device for use with the frame in a further embodiment according to the present invention.

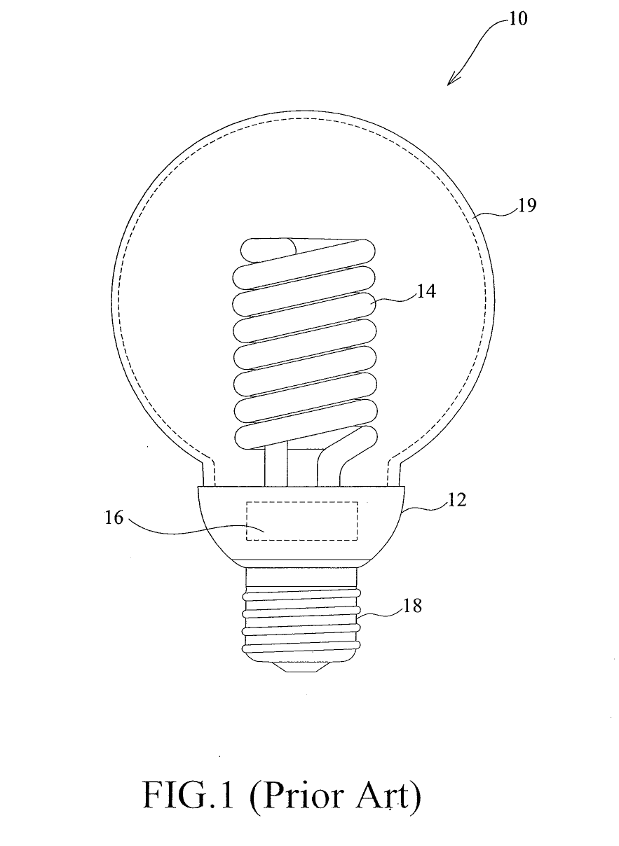

### DETAILED DESCRIPTION OF THE EMBODIMENTS

As mentioned earlier, conventional compact fluorescent lamp devices have drawbacks, such as the inadequate mechanical strength of a lamp tube, and the insufficient bonding between the lamp tube and the lamp holder. Hence, the present invention provides a lamp device and a frame for overcoming the drawbacks of the prior art. The embodiments of present invention are described hereunder, wherein structurally or functionally like components are denoted alike. The accompanying drawings are not drawn to scale but are intended to be illustrative of the structural features of the present invention.

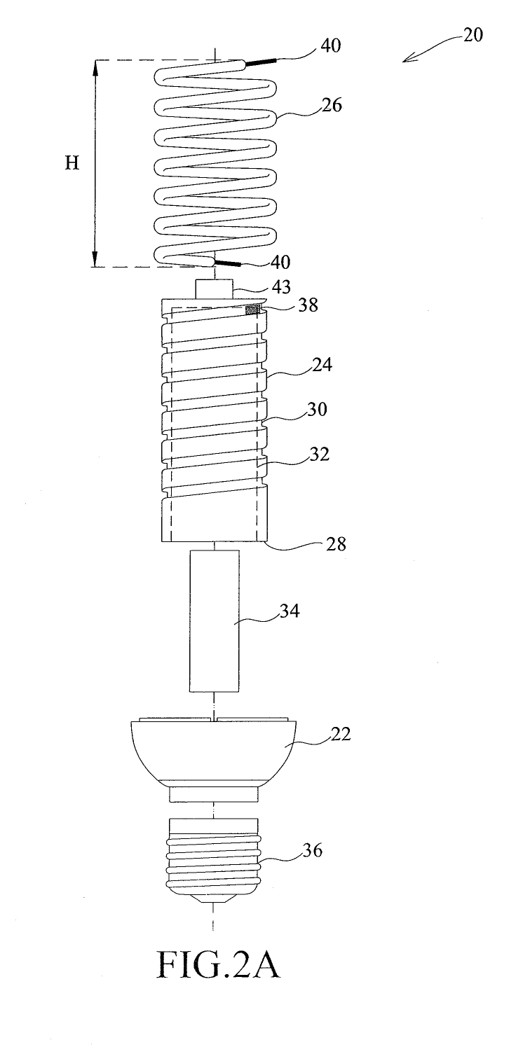

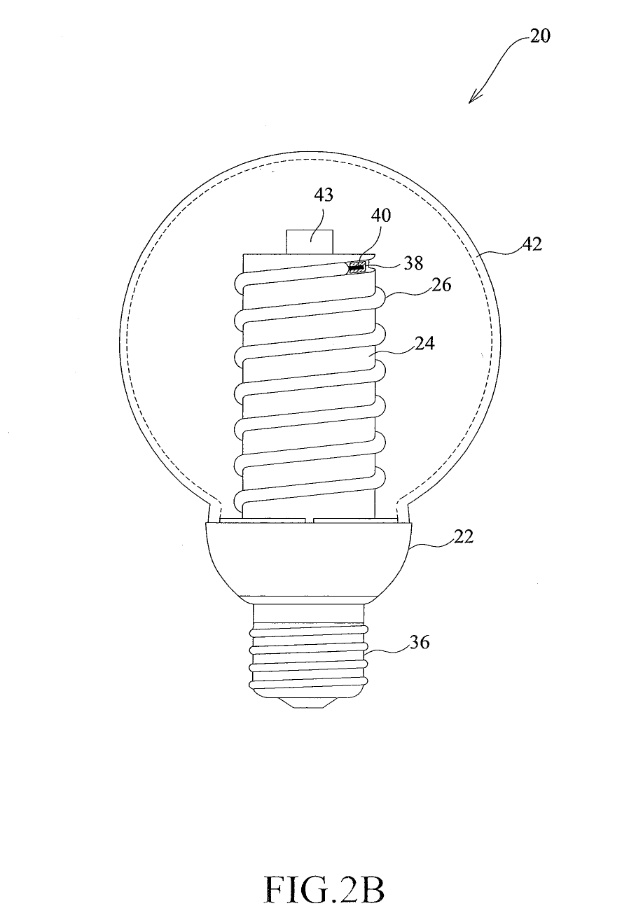

Referring to FIGS. 2A and 2B, there are shown diagrams of a lamp device 20 before and after assembly thereof in an embodiment according to the present invention. As shown in FIGS. 2A and 2B, the lamp device 20 essentially comprises a lamp holder 22, a frame 24 on the lamp holder 22, and a lamp tube 26. In this embodiment, the lamp device 20 is exemplified by a compact fluorescent lamp. The lamp tube 26 is a single helical cold cathode fluorescent lamp tube whose advantages include high brightness, satisfactory ON-OFF switching characteristics, and a long service life. Alternatively, the lamp tube 26 can be an electrode fluorescent lamp tube, hot cathode fluorescent tube, or the like. The above examples of the lamp tube 26 should not limit the present invention. In general, cold cathode fluorescent lamp tubes have a small diameter that ranges between 2 mm and 10 mm. The lamp tube 26 is usually made of a brittle material, such as glass. Hence, the lamp tube 26 requires additional special protection.

In this embodiment, the lamp tube 26 is of a height H, and at least one third of the height H of the lamp tube 26 is in direct or indirect contact with the frame 24 so that the mechanical strength of the lamp tube 26 is improved. Preferably, at least three-fourths of the height H of the lamp tube 26 is in contact with the frame 24, so that the lamp tube 26 can receive much better support. In this embodiment, the frame 24 has one end provided with a coupling member 28, such as a helical structure or an engaging structure (not shown), therefore the frame 24 can be screwed to or engaged with the lamp holder 22.

In this embodiment, the frame 24 is exemplified by a round post. A surface of the frame 24 comprises a groove 30. The groove 30 corresponds in shape to at least part of the lamp tube 26 such that the groove 30 can receive the lamp tube 26. In this embodiment, with the lamp tube 26 being of a single helical shape, the groove 30 can assume a helical shape as well. Also, the lamp tube 26 can encircle the frame 24. Alternatively, in other embodiments, the lamp tube 26 is a linear lamp tube, a U-shaped lamp tube with a bending portion, or a helical lamp tube. The helical lamp tube further comprises lamp tubes of double helical, semi-helical, full helical, or conical shapes, or any other shapes, which should not limit the present invention. The frame 24 and the groove 30 are designed in any way as needed. For example, the frame 24 is square-shaped, cone-shaped, or post-shaped. The shape of the groove 30 is subject to changes, according to the lamp tube 26 used. The inner wall of the groove 30 of the frame 24 is curved or polygonal (such as V-shaped or U-shaped). The lamp tube 26 is embedded, in part or in whole, in the groove 30 of the frame 24.

In this embodiment, the height of the lamp holder 22 is, preferably, less than that of a portion of the lamp tube 26, wherein the portion of the lamp tube 26 is located most proximate to the helical threads of the lamp holder 22. In so doing, the lamp tube 26 is unlikely to be hidden by the lamp holder 22, thereby minimizing the chance of reducing the luminous efficiency or luminous flux of the lamp device 20.

In this embodiment, the frame 24 comprises a hollow internal chamber 32 when the frame 24 is post-shaped. For example, a circuit board 34 which functions as a starter and/or a stabilizer for the lamp tube 26, is disposed in the hollow internal chamber 32 and electrically connected to the lamp tube 26, so as to reduce the volume of the lamp holder 22 and thereby downsize and beautify the lamp device 20. An external electrical connection structure 36, such as a screw thread contact, is connected to the lamp holder 22, thereby allowing the circuit board 34 to be electrically connected to an external power source.

In this embodiment, the frame 24 comprises an opening 38, and one end of the lamp tube 26 has a wire of an electrode 40. The wire of the electrode 40 is configured to pass through the opening 38, so as to be electrically connected to the circuit board 34 by soldering. The lamp tube 26 is directly fixed in position when supported by the frame 24. In this embodiment, the lamp tube 26 which is of a single helical shape can mate with the groove 30 of the frame 24 by following the course of the groove 30. The lamp tube 26 is resilient to some extent; hence, the lamp tube 26 can also mate with the groove 30 of the frame 24 by insertion.

Referring to FIG. 2B, the lamp device 20 further comprises a lamp shade 42 connected to the lamp holder 22 and configured to enclose the lamp tube 26 and the frame 24, so as to protect the lamp tube 26. However, in this embodiment, the lamp tube 26 is embedded, in part or in whole, in the groove 30 of the frame 24; hence, the frame 24 can, on its own, protect the lamp tube 26. In so doing, this embodiment dispenses with the lamp shade 42 to thereby cut the costs which might otherwise be incurred in manufacturing or assembling the lamp device 20, not to mention that the overall volume of the lamp device 20 can also be reduced.

In this embodiment, with the groove 30 being positioned on an external surface of the frame 24, enhancement of the brightness of the lamp device 20 requires that the frame 24 comprises an external surface that demonstrates reflective properties. For instance, a reflective layer or a reflective structure is formed on an external surface of the frame 24 by coating, immersion, electroplating, technique of a micro-electro-mechanical-system, or any other appropriate means. Alternatively, the frame 24 is made, in whole, of a reflective material, so as to enhance the brightness of the lamp tube 26. Also, the frame 24 can be made of metal, plastics, rubber, or any other material as needed. Considering that the lamp tube 26 is positioned proximate to the frame 24, and that the brightness of the lamp tube 26 comes to a maximum within an appropriate range of temperature, the frame 24 can be made of a material that meets a need associated with a specific portion of the lamp tube 26. For example, a portion of the frame 24 can be made of a material effective in dissipating heat, if the portion of the frame 24 is located proximate to the high-temperature electrode 40 of the lamp tube 26, so as to meet the need for heat dissipation of the lamp device 20.

In an embodiment of the present invention, to facilitate assembly, the frame 24 is further provided with an operating member 43 located at a portion of the frame 24, wherein the portion of the frame 24 is not in contact with the lamp tube 26, therefore the frame 24 can be disposed on the lamp holder 22 or the lamp tube 26 can be fixed to the frame 24, while an assembly process or an operation process is being carried out by an assembly worker or while the frame 24 is being held and supported by means of an assembly instrument. In this embodiment, the operating member 43 is exemplified by a protruding member positioned at one end of the frame 24, which, however, should not limit the present invention.

In this embodiment, the frame 24 is positioned on the lamp holder 22, and at least three-fourths of the height H of the lamp tube 26 is in contact with the frame 24; hence, the mechanical strength of the lamp tube 26 is improved because of the frame 24. Also, the circuit board 34 is disposed in the hollow internal chamber 32 of the frame 24 to thereby reduce the volume of the lamp holder 22; as a result, the lamp device 20 is downsized and beautified. In addition, the lamp tube 26 is disposed on an external surface of the frame 24, and the external surface of the frame 24 demonstrates reflective properties; hence, the brightness of the lamp device 20 is enhanced. Moreover, the lamp tube 26 is received in the groove 30 of the frame 24; hence, the lamp tube 26 is well supported and protected to thereby dispense with the lamp shade 42, enhance the brightness of the lamp device 20, and reduce the volume of the lamp device 20.

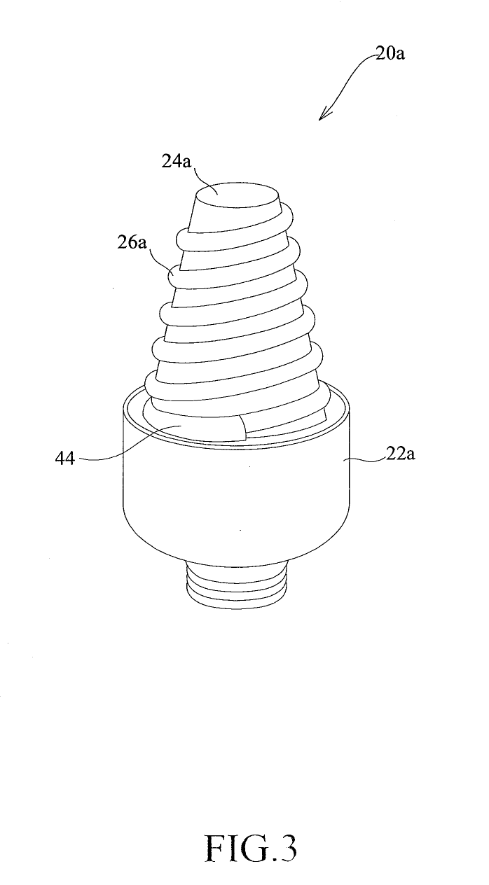

However, the present invention is not limited to various aspects of the aforesaid embodiment. FIG. 3 is a simple schematic view of a lamp device 20a provided in another embodiment according to the present invention, wherein structurally or functionally like components are denoted alike; hence, a detail description of this embodiment is omitted herein for the sake of brevity. Referring to FIG. 3, a frame 24a is a conical post, and a lamp tube 26a is a conical full-helix lamp tube. In this embodiment, the frame 24a is disposed on a lamp holder 22a, and the frame 24a lacks a groove structure. The mechanical strength of the lamp tube 26a is improved, because the lamp tube 26a is in contact with an external surface of the frame 24a. In this embodiment, one end of the lamp tube 26a is fixed to the lamp holder 22a by means of a securing element 44 of the lamp holder 22a. In this embodiment, the lamp tube 26a is of a full-helix shape, and thus the securing element 44 of the lamp holder 22a has a tunnel, and one end of the lamp tube 26a can be inserted into the tunnel to thereby be fixed to the lamp holder 22a. In this embodiment, preferably, the height of the lamp holder 22a does not exceed that of a portion of the lamp tube 26a, wherein the portion of the lamp tube 26a is located most proximate to the lamp holder 22a, such that light emitted from a lower portion of the lamp tube 26a is not blocked by the lamp holder 22a (wherein the lower portion of the lamp tube 26a is located proximate to the lamp holder 22a), and thus the luminous efficiency and luminous flux of the lamp device 20a is not compromised.

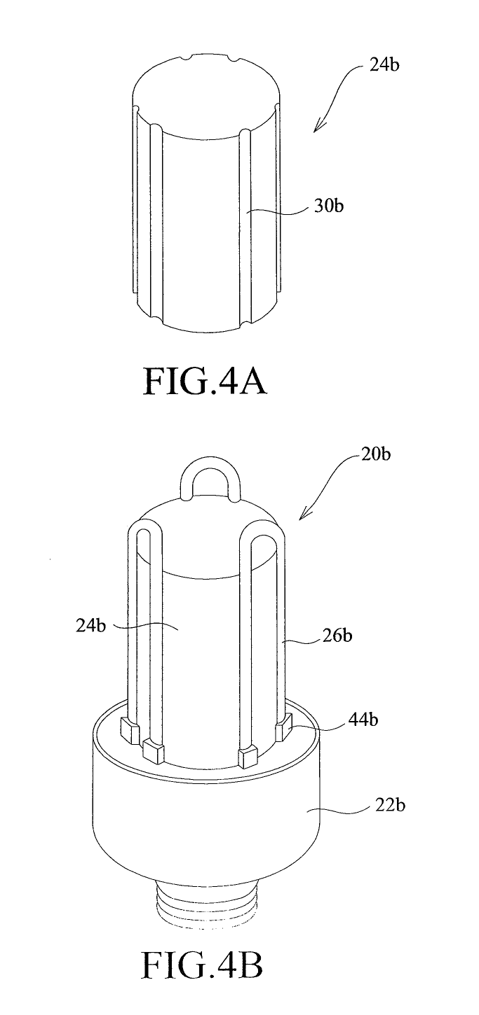

Referring to FIGS. 4A and 4B, there are shown simple schematic views of a frame 24b provided and a lamp device 20b for use with the frame 24b in yet another embodiment according to the present invention, wherein structurally or functionally like components are denoted alike; hence, a detail description of this embodiment is omitted herein for the sake of brevity. As shown in FIGS. 4A and 4B, the frame 24b is a cylindrical post, and a lamp tube 26b is a U-shaped structure. The frame 24b comprises a groove 30b corresponding in shape to at least one portion of the lamp tube 26b, so that the at least one portion of the lamp tube 26b can be received by the groove 30b, thereby enhancing the mechanical strength of the lamp tube 26b. However, in other embodiments, the groove 30b of the frame 24b might not be required; instead, the mechanical strength of the lamp tube 26b can be improved solely by allowing the lamp tube 26b to be in contact with a surface of the frame 24b. In this embodiment, a lamp holder 22b comprises a protruding member that functions as a securing element 44b, and the lamp tube 26b is fixed to the lamp holder 22b by means of the securing element 44b. However, the securing element 44b is not limited to the aspect of the embodiment; in other words, the securing element 44b can also be a ring-shaped member positioned on the lamp holder 22b or on the frame 24b, allowing the lamp tube 26b to be inserted into the ring-shaped securing element 44b and thereby directly or indirectly fixed to the lamp holder 22b. In this embodiment, preferably, the height of the lamp holder 22b does not exceed that of an exposed root portion of the lamp tube 26b, such that light emitted from a lower portion of the lamp tube 26b is not blocked by the lamp holder 22b (wherein the lower portion of the lamp tube 26b is located proximate to the lamp holder 22b), and thus the luminous efficiency and luminous flux of the lamp device 20b is not compromised.

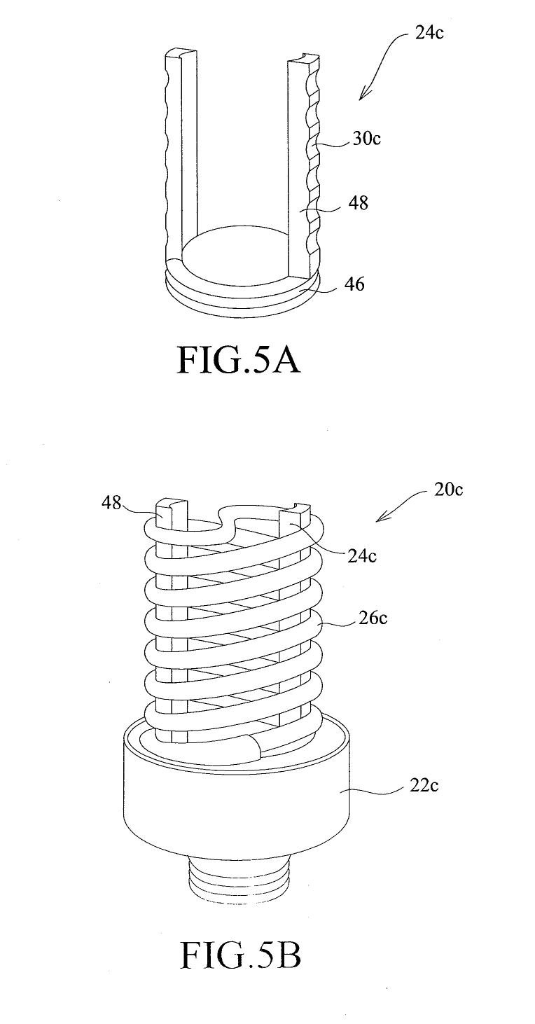

Referring to FIGS. 5A and 5B, there are shown simple schematic views of a frame 24c provided and a lamp device 20c for use with the frame 24c in yet another embodiment according to the present invention, wherein structurally or functionally like components are denoted alike; hence, a detail description of this embodiment is omitted herein for the sake of brevity. As shown in FIGS. 5A and 5B, the frame 24c comprises a base 46 and at least one extended member 48 connected to the base 46. The extended member 48 is a sheet-shaped structure or a strip-shaped structure. The extended member 48 is in direct or indirect contact with a lamp tube 26c, so as to improve the mechanical strength of the lamp tube 26c. In this embodiment, with the extended member 48 being a sheet-shaped structure or a strip-shaped structure, the extended member 48 is resilient to some extent and thus conducive to an assembly process whereby the extended member 48 and the lamp tube 26c are put together.

In this embodiment, although the base 46 is connected to a lamp holder 22c, the present invention is not limited to the aforesaid aspect of this embodiment. In fact, the extended member 48 can also be connected to the lamp holder 22c. Alternatively, the base 46 and the lamp holder 22c can be a unitary structure. Alternatively, the extended member 48 can be derived and extended from the lamp holder 22c.

In this embodiment, a surface (such as an external surface) of the extended member 48 comprises a groove 30c, and the groove 30c corresponds in shape to at least one portion of the lamp tube 26c, so as to receive the lamp tube 26c.

In this embodiment, preferably, the height of the lamp holder 22c does not exceed that of the lower portion of the lamp tube 26c, such that light emitted from the lamp tube 26c is not blocked by the lamp holder 22c, and thus the luminous efficiency and luminous flux of the lamp device 20c is not compromised.

A frame and a lamp holder of a lamp device provided in the embodiments according to the present invention each comprises separable components and thus can be recycled. However, in some situations, the frame and the lamp holder together form a unitary structure so as to simplify the assembly process.

Although the present invention is disclosed herein by several aforesaid preferred embodiments, the aforesaid preferred embodiments are not intended to be restrictive of the present invention. It should be understood by persons skilled in the art that many modifications and variations can be made according to the spirit and principle in the disclosure of the present invention and still fall within the scope of the invention as set forth in the appended claims. Hence, the scope of the claims of the present invention shall be defined by the appended claims.

What is claimed is:

1. A lamp device, comprising:
a lamp holder;
a frame on the lamp holder; and
a lamp tube having a height, wherein at least one third of the height of the lamp tube is in contact with the frame so that mechanical strength of the lamp tube is improved.

2. The lamp device of claim 1, wherein the frame is a post.

3. The lamp device of claim 1, wherein the frame comprises a hollow internal chamber.

4. The lamp device of claim 3, further comprising a circuit board disposed in the hollow internal chamber and electrically connected to the lamp tube.

5. The lamp device of claim 4, wherein the frame comprises an opening, and the lamp tube has an end provided with an electrode penetrating the opening to be electrically connected to the circuit board.

6. The lamp device of claim 1, wherein the lamp tube is in contact with an external surface of the frame.

7. The lamp device of claim 1, wherein a surface of the frame comprises a groove.

8. The lamp device of claim 7, wherein the groove corresponds in shape to at least one portion of the lamp tube, so as to receive the lamp tube.

9. The lamp device of claim 7, wherein the surface is an external surface of the frame.

10. The lamp device of claim 1, wherein the frame comprises a base and at least one extended member connected to the base, allowing one of the base and the extended member to be connected to the lamp holder, and allowing the lamp tube to be in contact with the extended member of the frame.

11. The lamp device of claim 10, wherein the extended member is a sheet-shaped structure or a strip-shaped structure.

12. The lamp device of claim 11, wherein an external surface of the extended member comprises a groove.

13. The lamp device of claim 12, wherein the groove corresponds in shape to at least one portion of the lamp tube, so as to receive the lamp tube.

14. The lamp device of claim 1, wherein the frame has an external surface provided with a reflective structure.

15. The lamp device of claim 14, wherein the frame is made of a reflective material.

16. The lamp device of claim 1, further comprising a lamp shade connected to the lamp holder and configured to enclose the lamp tube and the frame.

17. The lamp device of claim 1, wherein the lamp tube has a bending portion.

18. The lamp device of claim 17, wherein the lamp tube is a helical lamp tube that encircles the frame.

19. The lamp device of claim 1, wherein the frame has an end provided with a protruding member conducive to assembly, operation, or support.

20. The lamp device of claim 1, wherein the lamp tube is a cold cathode fluorescent lamp tube.
